(19) United States
(12) Patent Application Publication
(10) Pub. No.: US 2023/0337607 A1
(43) Pub. Date: Oct. 26, 2023

(54) MULTI-TIERED THERMODYNAMICALLY EFFICIENT FOOD, FEED, AND BIOENERGY PRODUCTION SYSTEM

(71) Applicant: Robert Brooks Rankin, Huntsville, AL (US)

(72) Inventor: Robert Brooks Rankin, Huntsville, AL (US)

(21) Appl. No.: 18/305,166

(22) Filed: Apr. 21, 2023

Related U.S. Application Data
(60) Provisional application No. 63/363,337, filed on Apr. 21, 2022.

(51) Int. Cl. A01G 31/00; A01G 27/04; A01K 1/00; A01G 15/00; A01K 61/00; A01G 33/00

(52) U.S. Cl. CPC A01G 31/00; A01G 27/04; A01K 1/0047; A01G 15/00; A01K 61/00; A01G 33/00

(57) ABSTRACT

A tiered, modular agriculture system includes a livestock module at ambient ground level and a second module having a second interior microclimate elevated with respect to the livestock module. The second module receives air from the livestock module by way of a noncorrodible, graduated slope, heat collection duct. Each module has an interior microclimate.

### CROSS-REFERENCE TO RELATED APPLICATION

This application claims the benefit of priority of U.S. provisional application No. 63/363,337, filed Apr. 21, 2022, the contents of which are herein incorporated by reference.

### BACKGROUND OF THE INVENTION

The present invention relates to production systems and, more particularly, to a multi-tiered thermodynamically efficient food, feed, and bioenergy production system.

Inflationary monetary policy in the petrodollar system has had many unforeseen negative externalities such as harmful effects on human health due to consolidation, adverse effects on the family unit due to both parents working which has caused negative ripple effects on children, families, human health, and society. In addition to the aforementioned negative externalities of inflationary monetary policy, dependence on a handful of multinational petrochemical companies, fertilizer companies, food conglomerates that promote the use of petrochemical pesticides, herbicides, fertilizer and fuel which, through forced economic consolidation in laterally integrated monoculture food production systems, destroy the pillars of local communities which are historically farming families which support local charities, community volunteers such as coaches, scout leaders, etc.

Microprocessors and the information age will lead to less need for protection from a centralized government which only expends 3% of its tax revenue on police protection at a state and local level. Most smaller farmers growing commodities using conventional monocropping systems are trapped in an unsustainable cycle through biotechnology seed consolidation. These farmers are just a hair away from going out of business during many periods of the business cycle because they can't achieve the scale necessary to harness enough profit in the commodity price cycle to continue to operate when profitability drops due to weather events, input cost increases such as biotechnology seed consolidation, etc. Their profit margin is so small that neither the farmer nor his banker will allow any deviation from a business model that is scalable but only cyclically profitable and is increasingly dependent on petrochemical fuels, fertilizers, herbicides, and pesticides. Inflationary economic policy has supported consolidation and ensured that the largest, mechanized farms emerged as the chief beneficiaries of price support policies. Agribusiness corporations with concentrated market share possess leverage to deter small producers from exposing anti-competitive practices in the industry.

Land and seed once belonged to no one and were shared by all, replicating the giving essence of the natural world. Today, these precious resources are tightly controlled and commoditized inputs. The modern U.S. food and agriculture system is designed to maximize a narrow concept of economic efficiency which fails to prioritize the well-being of small family farmers, rural communities, or the land.

Presently, current designs for animal agriculture production systems use more water, land, and energy resources than other plant based or cellular food production systems. Current commercial grain and forage production systems rely on lateral integration, economics, and comparatively limited market opportunities. Conventional animal agriculture production systems are not well integrated for multiple market value added production of fresh fruits, vegetables, dairy, meat, poultry, fish, shrimp, bioenergy production, and food waste recycling. The current conventional agricultural production systems are designed for the consolidation trend of horizontal integration in agriculture systems promoting monoculture crop systems and unsustainable food production systems which reduce the ability of soil to regenerate microbial populations or soluble nutrients, while causing soil erosion and siltation of aquatic habitats. The fossil fuel dependence on petrochemical fuels fertilizers and pesticides may progressively become more costly and problematic due to decreasing the soil ability to regenerate itself, and the finite amount of fossil fuel derived fertilizers which contribute to carbon dioxide (CO₂) emissions and climate change.

Warm-blooded animals require a lot of energy to maintain a constant body temperature. Mammals and birds require much more food and energy than do cold-blooded animals of the same weight. Larger warm-blooded animals stay warm easier because they lose heat proportional to the surface area of their bodies and produce heat proportional to their mass. This means that larger warm-blooded animals can generate more heat than they lose and can more easily keep their body temperatures stable. Smaller warm-blooded animals lose heat more quickly and may lose heat faster than they can produce it. High energy needs per calorie of food, feed, forage, and medicinal plant produced with current systems squander productivity of available resources such as land and water while raising transportation costs by producing a limited variety of products for distant markets.

The metabolism of food within the body is often referred to as internal combustion since the same byproducts are generated as during a typical combustion reaction—carbon dioxide and water. And like combustion reactions, metabolic reactions tend to be exothermic, producing heat. A 155-pound pig produces about 740 British Thermal Units (BTU) (217 W), while a 265-pound pig produces about 932 BTU (274 W)—that is a lot of heat to be dissipated by the pig, ventilation system and surroundings. Cattle produce between 4500 BTU/hour and 6000 BTU/hr. Mature pigs are most comfortable when air temperatures are between 50-75° F. Once temperatures exceed 80° F., pigs over 100 lbs. can very quickly move into life-threatening levels of heat stress. The ideal temperature for chickens is about 70-75 degrees Fahrenheit. Generally, the ideal summer temperature for a greenhouse is 75-85° F. during the day and 60-76° F. at night. In the winter, this changes to 65-70° F. in the day and 45° at night.

Consolidation and lateral integration of food production has caused longer supply chain routes, of thousands of miles in some cases, which lowers the shelf life, quality, and enzyme value and raises the cost of food by limiting commercial production to specific microclimates. Most commercial fruit and vegetable production is concentrated within specialized microclimates and soil types causing huge inefficiencies in transportation and distribution of fruits and vegetables as well as some fruits and vegetables being bioengineered to increase shelf life with enzymatic and nutritional value being a secondary concern. Current systems waste wood, food, nutrient streams, biomass, exothermic animal heat, solar heat, and combustion energy. Food waste is responsible for 2 gigatons of global emissions. Food waste represents $240BB or $2K per household.

Current models for animal agriculture production promote monoculture crop systems, petrochemical fertilizers and pesticides, inefficient transportation and distribution systems that span thousands of miles in some cases. There are human health issues associated with lack of dietary and soluble fiber intake in areas that cannot commercially grow fruits and vegetables or high-quality proteins like fish and shrimp.

Highly processed food is cheaper in the short term for consumers but raises health care costs over time within the human population. Human health issues associated with higher consumption of processed foods within food deserts are caused in part by economic and environmental factors, causing consolidation and concentration of food production to only the highest productivity growing areas.

Current commercial dairy and beef livestock housing design allows heat to spill passively from an open roof vented ridge line. The existing design for commercial livestock housing cooling fan orientation wastes energy by competition from crosswinds and headwinds as the fans operate continuously while the ventilation energy is disbursed to varying extents in the wrong directions. Current tunnel ventilation livestock housing designs waste the heat energy produced by livestock. Current livestock housing designs do not harness geothermal energy or incorporate liquid desiccant cooling systems to address livestock heat stress and seasonality of production. Heating is one of the largest, if not the largest, production costs in conventional greenhouse, poultry, and egg production systems.

Current greenhouse designs waste excess solar heat collected in greenhouses and use nonrenewable energy sources to provide supplemental heat to greenhouses, poultry, and egg production facilities. Most existing fungiculture production systems do not harness passive vacuum duct geothermal trench energy.

Many reverse osmosis water systems waste from 3 to 20 times the potable drinking water than they produce.

The average American meal travels 1500-2500 miles to get to the plate. At a typical Thanksgiving dinner, the food logs more miles to arrive at the dinner table than the family does. This is not only inefficient but also unhealthy. A fruit or vegetable loses nutritional value every second that passes from the time it is harvested. A two-week travel time can reduce the nutritional value of food by as much as 45%. Between 50% to 80% of the production cost of vertical farms is currently labor costs.

Wind and solar energy generation systems have been on an exponential cost reduction path. Wind energy production costs per watt in 1977 cost $77. Today, a windy location costs $0.02, $0.04 without subsidy; a 74% cost reduction. Coal, a hydrocarbon energy source currently costs $0.06/watt to produce. Wind energy systems are projected to reduce production costs by half in the next 10 years with $0.01/watt wind energy by 2030. Over the past 40 years, there has been a −300× cost to produce a solar panel with a solar cost of 0.30/watt today. Solar is the cheapest form of energy today in equatorial regions. The production curve of solar is like nothing that has ever been seen in energy production. The wind tends to blow when the sun doesn't shine, so it's kind of like adding 1+1 to get 3 on the energy balance.

Some commodity analysts predict crude oil prices as high as $400 per barrel by the end of this decade. A power purchase agreement (PPA), or electricity power agreement, is a contract between two parties, one which generates electricity (the seller) and one which is looking to purchase electricity (the buyer). The PPA defines all the commercial terms for the sale of electricity between two parties, including when the project will begin commercial operation, schedule for delivery of electricity, and penalties for under delivery, payment terms, and termination. Such agreements play a key role in the financing of independently owned (i.e., not owned by a utility) electricity generating assets. The seller under the PPA is typically an independent power producer (IPP) Network adoption of renewable energy certificates (REC) for green energy produced by renewable livestock bioenergy industry via social media. When a renewable energy supplier, like a wind or solar farm, produces 1 MWh of electricity, exactly one renewable energy certificate (REC) is created. That REC can now be purchased and retired by anyone who uses 1 MWh of electricity, officially using renewable energy.

Environmental policy in the United States causes extremely costly delays and inefficient use of capital for infrastructure projects. For example, in New York City subways cost $1 billion per kilometer, whereas internationally, subways cost $250 million per kilometer.

Locally grown food is more nutritionally dense and healthier and thereby more valuable. Larger nation states may fractionate in the future, exacerbating the need for decentralized food production within smaller geographic areas that would benefit from the ability to grow a wide variety of foods locally with fewer natural resources and naturally occurring microclimates. As societies divide and nation states fracture, food security and renewable energy production at a local level will become increasingly valuable. Dual circulation involves expanding domestic demand, focusing on the domestic market, improving the country's capacity for innovation, reducing dependence on foreign markets, and at the same time remaining open to the outside world.

As in Long Gamma, Short Gamma Vega strategy, volatility can't be predicted nearly as well as it can be reacted to, so a system that is scarcity focused and produces a wide variety of food and medicine and can easily adapt within market shifts is an anti-fragile food production system. Systems subjected to randomness build mechanisms to adjust beyond the robust to opportunistically reinvent themselves each generation with a continuous change of population and species. A system may insure itself by keeping mistakes small enough that the business can survive them. Crop insurance expenses found in a standard commercial food production system can be reinvested to make this system increasingly resilient by deploying capital to increase productivity and revenue. The more variability there is within a system, the more anti-fragile it is and the less it is black-swan prone. Small, decentralized units with high variability are more anti fragile than large mono crop systems. This also applies to businesses, government administrations and very large mammals.

In an exponential world, prevention may outweigh stability in defeating existential risk. In the past hundred years, business success has been measured in size and stability, in number of employees, and in assets owned. AIRBNB® built the largest hotel chain in the world and doesn't own one hotel room. UBER® and LYFT® don't own a single cab. The World Food Programme (WFP) Maano-Virtual Farmers' Market (VFM) is an app-based e-commerce platform where farmers' surplus and buyers' demand for crops are advertised and traded, beginning in Zambia in May 2017. VFM provides a transparent, open, and trustworthy space for smallholder farmers and buyers to negotiate fair prices and deals.

Complex systems can only be built and understood from the bottom up. Applications in technology allow for new creation of value and resources by exploiting geographical and topographical frontiers.

It's only a matter of time before the U.S. Securities and Exchange Commission (SEC) mandates all publicly listed corporations disclose carbon emissions like corporations disclose financials. Between 1950 and 1984, as the Green Revolution transformed agriculture around the globe, world grain production increased by 250%. The energy for the Green Revolution was provided by fossil fuels in the form of fertilizers (natural gas), pesticides (oil), and hydrocarbon fueled crop irrigation systems. The peaking of world hydrocarbon production (peak oil) may lead to significant changes and require sustainable methods of production.

As can be seen, there is a need for a biosystem design that addresses animal agriculture, food, feed, medicine and energy production inefficiencies via caloric conversion to value and thermodynamic energy transfer systems, livestock heat stress, high transportation costs, environmental impact of high water consumption, methane production, organic nutrient overland flow runoff, and malodorous animal agriculture production systems enabling farms to be located closer to population centers, thereby decreasing transportation costs and associated fossil fuel consumption. There is also a need for a system that solves cyclical farm revenue instability caused by consolidation of horizontally integrated mono crop farming systems, agriculture scaling limitations, soil microbial health, and nutrient and moisture retention issues. There is further a need for a system that adds value to land previously considered marginally productive in its capacity for food, feed, forage, medicinal plants, and bioenergy while reducing livestock housing ventilation and energy consumption.

### SUMMARY OF THE INVENTION

In one aspect of the present invention, a tiered, modular agriculture system, comprising a livestock module at ambient ground level and having a first interior microclimate and a second module having a second interior microclimate elevated with respect to the livestock module and receiving air therefrom by way of a noncorrodible, graduated slope, heat collection duct.

These systems take advantage of the vacuum left by the failures of animal agriculture in the consolidated monocropping system business model. This system complements the current food production system in many ways and shores up areas in which the current food production system increasingly fails sociological heath, human health, and soil health. This system may compete in a scalable production system with cellular agriculture well into the future while reducing pesticide use and improving soil and human health in multiple environments, climates, soil types, and topographies. The multi-tier ductile multiple market food production system may stabilize and secure food supplies while reducing a dependency on fossil fuels regardless of broader supply chain disruptions. This system enables production of a wide variety of foods efficiently beyond the scope and control of multinational food conglomerates. The direct ventilation energy application for wind energy and renewable energy storage systems makes this system the most local market for renewable energy production and the most efficient system for generating food, medicine, and energy. Direct drive windmill ventilation via modified vertical axis wind turbines allows for greater efficiencies in harvesting wind energy in areas previously deemed too inefficient for harvesting wind energy via conventional wind turbine applications for both ventilation of the multi-tiered food feed and bioenergy production system as well as for generating electricity.

The fall of the nation state due to grossly inefficient returns on capital deployment and unsustainable design will result in a large need for this system. As data encryption of cryptocurrency allows for secure decentralized economies, there are other benefits to decentralized food production aside from decreased fossil fuel dependence and increased energy efficiencies.

The system described herein grows monetary energy rapidly by incorporating the benefits of and enhancing the concentrated energy and return on investment (ROI) of infrastructure capital expenditure features of the confined animal feedlot operation (CAFO) model with multiple forms of renewable energy and feed production. Profits created within the system can transfer that money energy into commodity contracts based on algorithmic predictions of price increase or decrease based of where droughts are occurring and areas where most of these crops are concentrated. The monetary energy may be tax-deferred in the form of caloric, enzymatic, and renewable energy in a rapidly scalable business model. The system has applications for more acres of farmland, soil types, farming systems and topographies and can facilitate both needs of isolation for populations as well as trade between countries by increasing the monetary energy efficiencies within the trade. A community or poorer country in need of food may apply monetary energy to purchase commodity futures contracts where the algorithm predicts crop production to be scarce or may purchase the actual food commodities at a cheaper price where the algorithm predicts an abundance of a certain crops production and a price drop. There may even be financing opportunities through municipal grant partnerships for the system. The benefits of the tiered agriculture system include, but are not limited to, holistic and ecologically integrated technologies, low-impact technologies, sustainable resource management, reduced taxation via carbon offsets, reduced machinery costs, reduced or eliminated land tillage energy costs, reduced feeding cost, reduced land costs, increased land productivity, reduced labor costs, reduced weed growth and pesticide use, reduced dependence on petrochemical fertilizers, pesticides and bioengineered crops, increased nutritional security via fresh local food enzymes, increased food security through reduced dependence on highly processed foods, crops able to be grown and harvested to the size and variety specifications of individual restaurants/chefs, open source production methods, multiple and diversified revenue streams, and/or multiple varieties of foods and medicines. With artificial intelligence (AI) control management systems and standardized interior microclimates created by multi-tiered ducted food production systems, a wide variety of plants and animals can be grown at most latitudes worldwide via a standardized process agnostic of language, culture and educational barriers that may otherwise exist. In this way, monetary energy in the form of food, medicine, feed, and renewable energy can grow sustainably at a rapid pace benefiting human health and the environment in an effective and scalable way.

This system allows for higher productivity with higher return on investment (ROI) on a wider variety of soil types and topographies. The ROI on wind energy infrastructure is greater within the system in areas with high average wind speed than in areas with low average wind speeds. Purchasing more acres of lower cost land reduces property taxes per acre while increasing photosynthesis efficiencies per dollar of capital deployed. This creates opportunities for low energy input perennial crops to supplant high energy and fossil fuel dependent corn which is limited largely to prime irrigated farmland.

The systems described herein may add value to a wide variety of land, soil types, topography, and geologies while reducing fertilizer and fossil fuel consumption via reduced transportation costs and greater nutrient and energy value utilization. Biosystems described herein generate climate-agnostic local food, feed, and bioenergy production in most climates on Earth, reducing transportation costs and increasing food quality and freshness, while improving soils. The system can give value to timberland, wetlands, prairie lands, and many topographies that are under productive or marginally productive. The system may increase the value of the food, feed and energy production capacity of sub-marginal soil types, topographies, and climates for animal agriculture, aquaculture, fruit, and vegetable production. This system may provide value to marginal farmland with suboptimal topographical features and soil types, in addition to wetlands, by increasing food, feed, and renewable energy production capabilities, while improving soil health in a manner that plant-based products by themselves do not. In this way, the model can affect all types and most acres of farmland, including prime farmland with efficient topographies, not just marginally productive soil types and topographies close to population centers.

Fresh food produced locally in a stable climate within the system addresses the human health issues of inflammatory disease caused by lack of fiber intake, cereal grain oils, lack of fiber in processed foods, high sugar and sodium content, and chemical preservatives and artificial constituents in highly processed foods. This system may generate local food and energy independence while addressing human health epidemics via the reduction in food deserts through decentralized local fresh food production. This system may address human health issues by providing a food production system for nutrient dense, fiber- and enzyme-rich food sources to climates that otherwise cannot produce them on a commercial scale. Food deserts do not otherwise locally produce a wide variety of food products.

The system optimizes supply chain efficiencies for food security, renewable energy production, environmental and soil enhancement as well as benefiting human health. In a turbulent world of rapid change, this system masters the art of prevention of existential risk through adaptability and agility. The same can be done with this system via fractional ownership of farmland and producing increasingly vast and varied quantities of food by harnessing exponential technologies.

The system is highly adaptable to many different markets and environments. Knowledge of and access to ready alternatives in markets and production is pricing power and protection. The system described herein addresses complexity through technology adoption and may provide multiple income streams via diversified markets for a robust and scalable business model, reducing farm income volatility. Equipment sensors and algorithms may gather and interpret data. Additionally, this system may enable an economic hedge against a housing market downturn by putting the multi-tiered thermodynamically efficient food feed and bio energy production system in the center of a large sod farm so that small ruminants such as sheep and goats as well as cows and poultry may graze the sod, producing food and thereby providing income to the sod farms.

In a “reduced overproduction” business model, the products produced can be scaled up or down in volume and replaced, as needed, with higher value products, accessing greater scarcity. Any overproduction of products that may occur within the system can be readily utilized within the system in other applications (medicine, food, feed, bioenergy, renewable energy, seed stock, fertilizer). In addition, to solve problems of over production inherent with vertically integrated systems, multiple markets are available for nutraceuticals, herbs, food feed and bio energy within the system itself, so nothing is wasted. This multiple market food production system lowers emissions, land use, and water use of each individual product production system alone.

Land is 90% of a farmer's wealth. In shifting more forage calories from pasture to higher demand crops via low energy input energy transfer systems within the multiple market food production systems, a farmer can increase the value of the land while lowering emissions and increasing soil health. The tiered system has an energy balance in excess of 100% so more energy comes out of the system than is put in, considering caloric energy, exothermic energy, solar energy, water energy, geothermal energy, wind energy, and efficiency. When combined with exothermic livestock heat recovery, the proposed bio system creates more than 100% energy balance as currently calculated by known conventional renewable energy sources. This system may employ a reuse of caloric energy, geothermal energy, wind energy, heat expansion, and building elevation and slope to efficiently maximize conversion value of oxygen to carbon dioxide (CO₂), and from geothermal energy to maximum caloric value in food feed and bioenergy production. Channeling entrained air ventilates the system more efficiently with less horsepower. Low input costs are associated with multiple overlapping synergies within the system, enabling high capital velocity and recurring revenue models.

Within a multi-tiered ductile livestock housing system that maintains ideal temperature ranges for livestock while reducing heat stress, there is an opportunity to feed a lower energy feed ration and profitability through increased longevity via more historically appropriate fiber intake of livestock and increased settling rates for breeding programs. Getting livestock pregnant (high settling rates) lowers carbon footprint lowering heat stress and increasing livestock comfort lowers carbon footprint. The climate within the system may remain near optimal for livestock, fruit, vegetable, and aquaculture, fungiculture and medicine production year-round. By creating and maintaining an optimum environment for the livestock within the system to the exclusion of the external environment the reduced stress lowers the carbon footprint by increased settling rates which also equates to higher profitability. The best ways to control temperature are through ventilation, shade cloth, and heating.

The system disclosed herein increases viability of sustainable agricultural production systems such as silvopasture operations by increasing profitability and energy concentration. Silvopastured systems with the thermodynamically efficient food feed and bio energy production system also provide a hedge against the destruction caused by disease of monoculture orchard crops or banana crops, or palm oil crops, for example due to monocropping systems. The combination of harnessing natural shade in the microclimate of trees and the optimum temperature created internally within the multitiered thermodynamically efficient food, feed, and bio energy production system increases the profitability of the operation and lowers the carbon footprint of livestock production.

The inventive system facilitates documentation and measurement of internal and external climate conditions, renewable caloric energy production, nutrient management, factors contributing to carbon sequestration and nitrogen availability, soil moisture, soil microbiome, and hydroponic/aquaponic nutrient load, in real time to predict yields and timing of harvest. Documenting makes a business better anyway.

A biosystem of the present invention may optimize and compound every feed and forage calorie into five times the value of feed and forage calories in existing commercial food production systems. A user may administer a selected nutrient system for a crop and microclimate environment to maximize feed and forage caloric value within the system. The forage and feed calories may be further compounded in value as food grade products, biochar media microbes, and nutrient inoculation fluid, fertilizer, aerobic treated compost tea, anaerobic digestate, feedstock nutrients from anaerobic digester effluent grow free floating aquatic plants producing starch and protein that is converted by enzymes to glucose, ethanol, silage, and livestock feed ensiled by glucose or other sugar source. The compounding values of feed and forage calories may share a closed loop relationship by and through conversion into heat energy, wind energy, vacuum energy, biomethane energy, biomethane direct heat energy, biomethane steam energy, bio steam electrical energy, bio steam process heat energy, and aquaculture water temperature regulation. The higher energy prices rise, the more valuable the compounding value of feed and forage calories become. There is not a more efficient and profitable system for integrated food feed and bio energy production. The direct ventilation energy application for wind energy and renewable energy storage systems makes this system the most local market for renewable energy production and the most efficient system for generating food, medicine, and energy. Direct drive windmill ventilation via modified vertical axis wind turbines allows for greater efficiencies in harvesting wind energy in areas previously deemed too inefficient for harvesting wind energy via conventional wind turbine applications for both ventilation of the multi-tiered food feed and bioenergy production system as well as for generating electricity.

The system described herein may produce food with zero waste. A zero-waste system benefits the environment, supply chain issues related to food security, and human health across a wide variety of food crops with a decreased dependence on fossil fuels. The system may address food waste by kiln-drying foods using recycled heat, harnessing geothermal energy to reduce cold storage costs, and recycling food waste for animal feed, bio energy, and fertilizer production. When applied to food production, a pre-planned site with topography, percolation rate, crops, stream vegetation buffers and overland flow scenarios accounted for in the zero-waste system populace can bypass delays and derive value from the inefficiencies of economic policy and standard commercial food production systems.

In addition, these systems can benefit smaller population centers located in remote areas, using tribal societies as a model which may be characterized by small, human-scale communities, low-impact technologies, successful population controls, sustainable resource management, holistic and ecologically integrated worldviews, and a high degree of social cohesion, physical health, psychological well-being, and spiritual fulfilment of their members.

The system described herein may replace any repetitive management task and any measurable management decision, so a franchise model of production is possible.

This system may provide a solution for ocean hypoxia by greatly reducing organic nutrient runoff.

A primary objective of the present invention regarding sustainable and renewable energy use is direct food production from energy and waste. Harnessing the exponentially reducing costs of renewable energy production technology as well as making photosynthesis more efficient are the fundamental goals of these systems which incorporate renewable energy generation, energy storage, and green transportation.

Another objective of the present invention is to cut 1 gigaton in emissions and to advance lower emission diets, as compared to emissions and diets prevalent at the time of writing.

These and other features, aspects and advantages of the present invention will become better understood with reference to the following drawings, description, and claims.

### BRIEF DESCRIPTION OF THE DRAWINGS

FIG. 1 is a schematic diagram of a positive pressure ventilated agricultural production system according to an embodiment of the present invention;

FIG. 2A is a schematic diagram of tiered units thereof;

FIG. 2B is a schematic diagram of a tiered configuration according to another embodiment of the present invention;

FIG. 3 is a perspective view of a wind scoop thereof;

FIG. 4 is a schematic view of a transition region across tiered units thereof;

FIG. 5 is a schematic view of a fungiculture unit thereof;

FIG. 6 is a schematic view of a fungiculture unit according to another embodiment of the present invention;

FIG. 7 is a top plan view of climate-isolated livestock housing unit thereof;

FIG. 8 is a schematic diagram of a greenhouse module thereof;

FIG. 9 is a side schematic view of a positive pressure ventilation turbine system thereof;

FIG. 10 is another schematic view thereof;

FIG. 11 is a schematic view of a serpentine aquaculture pond of the system of FIG. 1;

FIG. 12 is a schematic view of biochar production system thereof; and

FIG. 13 is a schematic diagram of a positive pressure ventilated agricultural production system according to another embodiment of the present invention; and

FIG. 14 is a top schematic view of the turbine system therefor.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a comprehensive system that produces conventional agriculture products and byproducts such as fertilizer; harnesses heat from livestock as a component of an internal combustion bio-engine; and produces wind and solar energy in a zero-waste process. This system may harness wind and heat energy to create vacuum ventilation in a multi-tiered ductile system, thereby reducing energy needed for ventilation.

The system utilizes a tunnel, dome, trench, or a series thereof, to move the most air with the least energy while using a vacuum vortex wind silo to harness energy from naturally rising heat. Exterior wind energy may be harnessed to further reduce energy needed for ventilating and maintaining multiple interior microclimate zones.

In some embodiments of the present invention, the system may comprise pre-engineered clear span buildings, including both clear translucent and white insulated coverings for clear span buildings. A white-colored building can reduce cooling cost by up to 60% as opposed to a black building. To collect solar energy in the form of heat, a black interior layer may be provided within a translucent glass or poly surface to absorb heat.

Building orientation may be selected to increase solar energy efficiency via solar geometry of buildings, enabling a smaller air conditioning system. For example, increasing photosynthesis efficiency per dollar of investment means that a farmer can purchase more acres of marginally productive land for less money than prime farmland because this system increases the value of feed and forage calories produced. In the Northern Hemisphere, a building facing south is subject to increased direct sunlight so that less energy is required to heat the building during cold weather and more electricity and/or heat can be produced. Building orientation can also be optimized to reduce the air conditioning system size that might otherwise be required to keep the building interior cool during warm weather.

Ruminant animals are furnaces that may be used to heat a greenhouse, poultry, and egg operations. The livestock housed in a temperature and humidity-controlled environment can optimize health and food production while beneficial use nutrient recovery systems can be optimized for maximum value recovery in food, feed, medicine, distillates, and energy. All food, feed, and energy value increases come sustainably from animal agriculture organic nutrient streams and exothermic animal heat. A system housing sheep differs from a system housing cattle. For example, small ruminants like sheep give off less heat than a larger ruminant like a cow, so the sheep livestock tunnel, the down gradient geothermal tunnel, and the upgradient greenhouse may be sized appropriately to achieve the ideal air flow, relative humidity, and temperature needs of sheep.

A conventional free stall livestock barn may be modified to serve as the ground level livestock housing facility within hybrid system conversion of existing livestock housing systems.

A swine production facility may supplant the room in the livestock production facility at ground level.

Air from the livestock module may be routed to a greenhouse with vertical horticulture towers. The vertical towers may be manufactured, for example, of polyvinyl chloride (PVC). The plants may be watered without pumps utilizing the following self-watering mechanism. A rayon wicking rope may be routed through the tower. Sealed funnels pointed downwards (reservoirs) are waxed or glued (affixed) to the rope, spaced apart about every 8 inches in series with cotton gin trash in the air space therebetween. Rayon is a highly absorbent fiber that wicks nutrient water or compost tea into the cotton gin trash at each level. The difference in wicking ability between the rayon rope to the cotton gin trash enables nutrient water to form a pool at the bottom of each sealed funnel. The pool waters the roots of the plants and enables water to wick upwards through the rayon rope to the next funnel.

In some embodiments, the center of each vertical column is mirrored to reflect sunlight, or light emitted by LEDs, to the plants in surrounding vertical columns.

In some embodiments, the nutrient water is formulated to mimic region-specific conditions representative of a physically separate location. Biochar may be used in the formulation process.

In some embodiments, the vertical farming greenhouse module may have a central PVC column having as a base a precast concrete bowl-shaped base that rides/floats (floatingly rests) within another concrete bowl-shaped support. About 2 inches of water separates the two concrete bowls, reducing friction between them. This allows the full weight of the growing columns in the vertical farming greenhouse to be turned with a very small motor, such as a ½ hp or 2 hp motor. The structural beam serves to keep them in balance from above.

The heat derived from the exothermic metabolism of livestock and heat derived from solar energy within the greenhouse may form an updraft which collects in the graduated up-gradient sloped heat collection duct. From the duct, the heated air is vacuumed into the vacuum vortex silo where it joins an updraft from the heat of a dry kiln and biochar process, generating interior wind with sufficient energy to turn a vertical axis turbine retrofitted with a scoop fan. The turbine and scoop fan force the air entrained in the rising vortex up through a raised solar heat collector, operative to generate electricity from air exiting the system and throttling diaphragm to combine with the atmospheric wind.

Alternatively, the heat from livestock can first be harnessed to lower the heating costs for up-gradient poultry, eggs, and greenhouse operations. For example, heat from livestock may generate an updraft into a graduated slope heat collection duct and pulled by a solar vacuum vortex silo into the floor level vents of the vertical tower hydroponic greenhouse. In other words, the floor vents are operative to receive air from the livestock module.

In some embodiments, an elevated poultry or egg production operation may be added. A poultry production or egg production facility may supplant ruminant animals.

In some embodiments, a livestock production housing facility and/or elevated greenhouse may be added upgradient of a ground level unit in the livestock facility or upgradient of the poultry and egg production facility.

In some embodiments, heated air from a livestock tunnel may rise and be collected in an upgradient sloped heat collection duct where the air is filtered and purified with salt infused biochar and an ultraviolet (UV) filter before being distributed into upgradient greenhouse floor vents.

In some embodiments, a water curtain is positioned between the modules to both cool the air and to aid in air filtration.

In some embodiments, activated carbon air filtration may be used in the system to address odor issues commonly associated with animal agriculture. For example, residential facilities up gradient of livestock production operations may be heated with air from the livestock production operations after it is filtered through activated carbon air filtration systems. The activated carbon used in these air filtration systems may be bio char produced onsite. Residential facilities may also or alternatively be located up gradient of a geothermal trench and may help regulate the temperature of the residential housing facility.

Warm air rises through the greenhouse and may be collected in an upgradient sloped heat collection duct and is deposited in the vacuum vortex silo at an angle which aids a turning of the modified vertical axis turbine. The vertical axis wind generator may be elevated to vacuum air or recessed to push air through the system. Alternatively, a vertical axis wind generator may be placed in both locations (i.e., lowest elevation and highest elevation) and modified to push and pull air simultaneously through the system. An augmented vertical axis wind generator or a standard vertical axis wind generator may assist with vacuum ventilation, or no wind generator may be used. The combination of wind and solar can achieve 80% of energy needs.

A ribbon of rollup doors on tracks act as a diaphragm throttling system for the vortex silo. The doors may be transparent, made of PVC or glass, and may roll on bearings on a track that is slightly twisted to create a leading-edge Vortex at the bottom to create and compound vibrations of bladeless wind turbines positioned on the floor of the vortex silo. This compounds the energy in electricity created as heat escapes the thermodynamically efficient multi-tiered ductile system. Bladeless wind turbines generate electricity for 40% less money as compared to traditional wind turbines. Bladeless turbines can be used both on and off the grid and in hybrid wind-solar systems.

Non-corrodible air distribution ducts and variable frequency driven fans may serve as a low-grade heat transfer system.

Moving parts in the system may be reduced by including pneumatic air cylinders, opening and closing air ventilation louvers, and water flush valves for livestock housing and hydroponic tower grow systems.

In some embodiments, a geothermal trench may be present at the ventilation system input to address livestock heat stress, depending on the climate. The geothermal trench is an ideal environment for mushroom production, addressing concerns with livestock, and the livestock heat rises to address a high heating cost in poultry production. However, plants that produce oxygen and take in carbon dioxide may also be grown under LED light in the geothermal trench. Exterior air may enter a geothermal trench or geothermal pipe system under an elevated greenhouse base. The greenhouse base may be supplied by earth and excavated from the geothermal trench. Air may be regulated by harnessing low input energy transfers in temperature and oxygen or CO₂ concentration for a benefit of the upgradient downstream portion of the system in which the air will enter. Appropriate climate parameters in each climate zone may be maintained as described herein.

The geothermal trench may be covered by insulative roofing material such as hollow core concrete panels. If water collects naturally in the geothermal trench, then a temperature regulated environment for aquaculture may exist and a floating marina dock may be assembled under a rack hanger structure for vertical farming and mushroom media bags.

A microclimate regulation relationship may exist between some or all microclimate zones. A geothermal fungiculture microclimate may be regulated by geothermal energy and prepares the air as it moves through a bioball, salt infused biochar air filtration, cooling, dehumidifying chamber and into a noncorrodible air duct distribution system to regulate livestock temperature. Each of the microclimate systems under clear span tunnel buildings may be up gradient of the previous microclimate and use the heat generated by the exothermic digestion of feed and forage calories.

If a system omits the use of a geothermal tunnel, cooling and dehumidifying of ventilation air distributed to livestock may be maintained and regulated by liquid desiccant systems.

Exterior air may enter the geothermal trench through a pivoting wind scoop which always faces into the wind and filters the air using salt infused biochar. The wind scoop creates a positive pressure air space in the geothermal trench independent of exterior wind direction to prevent any pathogens found in backflow of air from the livestock facility. The air may move through the trench and may be regulated before entering the bio ball and salt infused biochar air filter within the liquid desiccant air cooling system as cool air is distributed to livestock in non-corrodible air distribution ducts.

The dual concrete floatation construction described with respect to horticulture towers above may also be applied to the rotating wind scoop to reduce the number of moving parts and reduce any friction to fluid friction levels.

Subterranean temperatures in the geothermal trench cool air entering the livestock housing facility from the atmosphere at ground level, and the heat that the livestock produce rises to heat poultry and or hydroponic or aquaponics systems producing vegetables, fruits, herbs, and fish. The system may be a component of decentralized food production and can be applied at most latitudes worldwide addressing food shortages, fiber deficiencies, nutrient deficiencies renewable energy production, soil health, and supply chain issues at a local level. Decentralization of food production results in lower food insecurity through supply chain issues and fossil fuel dependance. These systems can be used in aggregate surrounding large population centers to increase food security and decrease fragility in this food supply chain. The anti-fragile approach to the farming business model runs counter to consolidation due to inflationary monetary policy that has been in place since the inception of the petrodollar system.

The base of the multi-tiered ductile system may be prepared using earth moving equipment, such as self-propelled dirt pans, bull dozers, track hoes, and dump trucks. Earth may be excavated from the geothermal trench and deposited to grade the livestock housing facility to flush to drain, and most of the excavated earth may be deposited around large diameter geothermal pipes to form the elevated base of the greenhouse, pyrolysis biochar production system, dry kiln, and vacuum vortex wind turbine silo.

In some embodiments, geologies with clay-based soils and/or impermeable chalk layers protect the water table. If soil type and geology features require pond liners or tanks, for example due to high percolation features, then those materials can be used in construction of system to protect the water table in those environments.

In some embodiments, the system comprises a promising alternative to land application of manure. Wood waste, biomass and manure solids can be converted via pyrolysis or gasification to heat, electricity, and biochar for a variety of uses. Pyrolysis of livestock manure produces biochar, bio-oil, and syngas. Pyrolysis at a temperature between 400-550° C. reaches a compromise between char pH and electrical conductivity for biochar use as soil amendment.

When used as a soil amendment, biochar increases the percolation rate and water absorption of clay-based soils, thereby reducing overland flow of organic nutrients. Biochar also increases the water retention capacity of sand-based soils. This system may address soil health by producing valuable nutrient sinks using bio char nutrient filtration systems to absorb organic nutrients.

Biochar in livestock feed rations reduces livestock methane emissions and antibiotic use.

Biochar may also be used in developing crop specific compost teas with region-specific nutrient profiles. Some biochar may provide soil nutrients and increase soil microbial populations from specific regions and microclimates, assisting in the growth of crops with flavor and nutrient profiles from a specific terroir or region. The chemical composition of agricultural effluent may be determined in a pipeline of an effluent collection system with chemical composition sensors. Designer hydroponic soil microbes and micronutrients may be added to replicate soil microbe and nutrient profiles in combination with terroir and region-specific microclimates via interior microclimate generation to produce high value crops with this system. In some embodiments, the system may include algorithms to produce designer bio char with crop and application specific profiles.

The bio char can be used in air filtration applications. Biochar may also be used to recover nutritional and microbial value from livestock nutrient streams and distribute nutrients and microbes to crops grown in vertical hydroponic towers or in flow bed medias. The bio char organic nutrient filtration of animal waste nutrients streams may also be used in many other organic nutrient filtration systems, such as municipal wastewater systems.

The system may comprise an aquaponics module and/or a hydroponics module. If hydroponic vertical tower farming methods are more appropriate for the local market than aquaponic systems, for example due to return on investment, then hydroponic systems can then be utilized within the system instead of aquaponic systems.

In some embodiments, the ventilation and vortex vacuum systems may be assisted by a multiple power source wind generator rotation assist system to improve efficiency on a more consistent basis.

Using lithium ion and salt flow batteries and aqueous sulfur flow battery technologies, energy can be stored for when the sun doesn't shine, and the wind doesn't blow. Stored energy can turn modified vertical axis wind turbines to directly ventilate from both the inlet and the outlet of the multi-tiered ductile food production system. The modified direct ventilation turbines can also be powered by alternating current electrical service from utilities in addition to being powered via motors powered by the direct current energy stored in batteries with energy generated by the wind turbines.

In some embodiments, the system may operate with standard AC power systems using fans with or without variable frequency drives. A Tunnel Jet Fan operated via weather stations and variable frequency motor drives can maintain optimal airflow within the multi-tiered habitats independent of modified vertical axis turbines (VATs with windmill scoop blades perpendicular to the ground which push air into the system and pull air out of the system depending on application and orientation of windmill blades). Airflow created by tunnel jet fans create vacuum at intake, exhaust at the vortex silo turns “direct drive” windmill blades and VATs even in the absence of any exterior atmospheric wind which generates electricity as air enters and escapes the system. The resultant generation of electricity by the turning of the modified VATs in the absence of atmospheric wind further increases the efficiency of energy applied to the tunnel jet fan. The circular configuration of the thermodynamically efficient food, feed, and bio energy production system could be considered an “internal combustion vortex engine”. See, for example, U.S. Pat. No. 7,086,823 B2 to Michaud, the disclosure of which is incorporated herein by reference.

Duckweed and aquatic plant production systems may be utilized in some geologies and topographies. Duckweed and aquatic plant production modules can be covered with low tunnel clear span greenhouse covers or surrounded with windbreaks.

The free-floating aquatic plant production, fermentation, and fractionation system may be land based or water-based on a modified barge producing food grade glucose and protein, ethanol, and animal feed or exclusively ensiled animal feed.

Duckweed protein is more like animal protein than any other edible plant. Duckweed protein can more cost effectively produce plant-based food products than any other source with lower fossil fuel use and lower pesticide and herbicide use. Sugars created by duckweed may be used for fermentation of synthetic proteins, animal feed, glucose production, ethanol, and food, and may also be used in gel caps for nutraceuticals and medicinal herbs produced in the greenhouse and fungiculture operation within the multitiered thermodynamically efficient food, feed, and bioenergy production system.

Evergreen trees and bamboo\switch cane can be configured in a north-south configuration to allow for greater efficiency as wind breaks to block the prevailing wind direction to increase the efficiency of duckweed and algae growth in aquatic feed production operations. To be eligible for organic certification, land may have no prohibited materials applied for three years immediately preceding harvest. Bamboo takes about three years to get established which coincides with the length of time to obtain organic certification.

Duckweed starch can be used as feed or converted into valuable sugar for fermentation into fuels, food ingredients or feed products. The aquatic feed can then be fermented to produce sugar, ethanol, and products derived from sugar and ethanol. The fermented remainder of the feed can be fed to livestock.

This energy produced by warm-blooded animals mostly comes from food. Food represents stored chemical energy (potential energy), which is converted into other forms of energy within the body when the food is metabolized. Metabolism refers to all a body's chemical reactions. A variety of plant types, including shrubs, grass, legumes, and forbs can make up the forage and browse components. Choices depend on the livestock component, must be tolerant of grazing, and must be productive under shade.

A small amount of seaweed in cattle feed may reduce methane emissions in beef cattle by 82%. Molasses may be used to ensure the seaweed is well mixed into the cattle feed.

Increases in caloric energy conversion efficiencies may also be achieved by utilizing forms of Vermiculture such as worm, cricket, and black soldier fly protein to reduce a “per dollar of investment” exposure to heat stress horticulture. Other forms of the systems benefit most by the ability to use the energy products and byproducts produced. In addition, vermifuge crop seeds can be blended into seed blends of the cropping system to address internal parasites of livestock without use of antibiotics.

Technologies such as fenceless grazing technologies and herding drones lower the capital costs of land improvements and operational costs on farms. A “zero grazing machine” may mow the outlying tracks of sod and bring the forage back to the system, creating feed and bio energy. In sod farm areas where housing and growth is expected to reduce the value of hundreds of thousands of acres of sod for lawns, this system can maintain the sod farm until the housing sector comes back in a low-cost manner. Zero Grazer technology allows more forage calories (crops) to be collected from greater distances than livestock can productively walk. This increases the capital efficiency of livestock infrastructure, increases revenue, and allows tax advantaged growth while addressing fractionation/division of farmland for higher utilization within the system. For example, zero grazing can optimize production yields of meat or milk.

As used herein, silvopasture when applied to open pastureland (without trees) refers to planting bamboo/river cane which is fast growing and can be used in a variety of products such as building materials, pulp/paper, biomass for energy production, and ruminant feed (leaves). The bamboo can provide shade and can be harvested incrementally without having to be replanted, thereby increasing the profitability and efficiency of the silvopastured operation. Currently, silvopasture systems primarily involve cattle, goats, or sheep but can incorporate poultry and rabbits as well.

The system enhances the profitability of silvopasture operations and growing systems by providing a form of harvestable concentrated energy. Timberland, which has been falling in real value over the past 15 years, can be purchased and partially harvested, leaving a double row of trees adjacent to a strip of pasture in an east-west configuration so that livestock can graze the grass in between the double rows of trees. The shade from the trees predominantly shades other trees rather than the grassy area, thereby increasing the efficiency of photosynthesis and enhancing the profitability and yield of the silvopastured operation. The livestock benefit from the microclimate around the trees including the shade and use the calories that would otherwise have been exerted for cooling, heating, or body maintenance to produce milk and meat, while fertilizing the soil and sequestering carbon. On existing pastureland, conical shaped trees can be grown to further increase photosynthesis in the pastured rows in an east-west configuration to minimize shade on the pasture, thereby increasing the efficiency of photosynthesis. The east-west configuration also allows the west to east Jetstream to move air (prevailing wind direction) to cool livestock in low wind via evaporative cooling/evapotranspiration. In high wind areas such as the plains states where wind breaks are beneficial to livestock in winter, a north/south configuration of trees is more suitable.

Food processing systems may be used in some embodiments.

Drone mapping of topography and soil and geological conditions specific to each location in which the system is placed can be used to reduce surface water runoff or groundwater pollution as well as topographically mapping areas, such as maps used for road construction.

Decentralized microcomputer controls may be utilized to maximize efficiency. With artificial intelligence and machine learning control systems, a multiple market food system can be specialized across the wide variety of crops and animals local to population centers. Control systems could be decentralized or centralized or a hybrid. Algorithms are employed to coordinate with weather stations within the system to create ideal environments for whatever is being produced within the specific microclimates. The algorithms control the rollup doors and diaphragm fan speeds, variable frequency drive on tunnel jet fan motors, variable frequency drives on pump motors pumping compost tea or recirculating water for aquaponic systems, activating solenoid and valve systems to operate misters on livestock affecting evaporative cooling of livestock, motors operating shade reels in a greenhouse, air vent bypass valves, knife valves, etc.

Each microclimate may be measured and controlled by weather stations operative to measure air characteristics and connected to a programmable logic control system that uses electric powered motors and pneumatic air actuated ball valves to increase or decrease the speed of ventilation fans or open and close louvers, diaphragms, valves, circuits and increase or decrease the rotation speed of pump motors. For example, the speed at which water is flowing within tanks may be optimized for fish growth, health, and energy expenditures. Controlling power of a pump motor can increase or decrease the speed of water passing through a venturi valve entraining oxygen into an aquaponic or hydroponic system.

In some embodiments, rollup doors or air louvers may be set and adjusted manually based on internal climate conditions.

Microcomputers may operate and monitor various parts of the system to maintain ideal microclimates for production of various food and energy products within the system. These microcomputers such as Raspberry Pi® may be interconnected via ethernet, WI-FI®, and/or Bluetooth®.

Air and water inflows and outflows (oxygen content, relative humidity, CO₂ content, dew point, air speed, air temperature, methane content) may be controlled and regulated through the various internal microclimate zones using data from internal weather stations to modulate louvers, valves, fan motor rotation, and pump motor rotation using programmable logic control programs. Roll up doors and air louvers may be controlled by weather stations, feeding information into operating systems that control airflow and relative humidity levels within the microclimates. Pneumatic water flush valves for livestock preprocessed feed and forage nutrients may be activated at intervals adequate to maintain a certain threshold of air quality, for example.

Use of planting and harvesting robots can lower labor costs, reduce management costs, and increase long term productivity by addressing issues associated with aging farm labor populations. The robots may be operated using AI and Machine Learning.

The system may also be used to predict how eating certain foods affects a person's specific metabolism, microbiome, endocrine system, etc. These predictive systems may utilize artificial intelligence (AI). In other words, the predictive analysis artificial intelligence system can be fluidly used from seed to human health consequence and outcome. AI fluid predictive analysis can be used in many other areas of food and energy production, medicine production, transportation, and logistics.

Pre-processed organic nutrients may be transferred into bio energy value and food and feed value within the system for the purpose of maximizing the value of each feed and forage calorie.

A software system that analyzes local markets for maximum value may identify scarcity and seasonality of food and feed products. The system may account for transportation cost of production scarcity and proximity to achieve the highest output with the lowest input, thereby maximizing feed and forage caloric value.

Market analysis software systems may be used in some embodiments for predictive fluid analysis to maximize feed caloric value. The airflow systems, water pumping systems, air quality monitoring systems and LED lighting systems may all be controlled by a central control system using predictive analysis.

The predictive analysis software system may also predict restaurant and food service needs and the time food products take to grow from a seed to delivery at the restaurant or food service system, while measuring and predicting nutrient requirements, microclimate requirements, labor requirements, and transportation requirements to deliver the product on time. As a result, the restaurant or grocery can reduce the amount of inventory while still meeting demand. Algorithms employed to predict crop growth rates and delivery dates enable chefs, for example, to better manage their inventories and provide the freshest ingredients possible. A fluid predictive analysis control system may measure the nutrient requirements from a seed or seedling in a hydroponic system to predict delivery time to a food service customer. Ladder logic adaptations using “yes when” or “if then” scenarios for nutrient, microclimate, and crop variety information, as well as timed scenarios, can fluidly predict a time from planting a seed until the product delivers to the customer, based on variations within the nutrient stream and the microclimate, seasonal hours of sunlight, and supplemental LED lighting.

Algorithms to produce batch mixes of designer bio char inoculated by compost tea with the soil nutrient and enzymatic profiles of specific soil types in microclimates to grow products that closely resemble food products produced in specific terroirs and microclimates at most latitudes worldwide within the system to access scarcity while addressing supply chain issues. The designer compost tea and designer bio char are grown and scaled using glucose produced by enzymatic conversion of starches from free-floating aquatic plants used as a feedstock to grow the nutrient profiles specific to crops from specific regions, soil types, and microclimates. Algorithms may also be employed to predict the greatest scarcity and highest profitability crops to grow within certain markets based on demographic and income criteria along with location and proximity to microclimates growing products that must be transported long distances. Variables and transportation costs such as fuel cost, oil price, and electricity cost can be fluidly factored into production analysis and control systems to predict return on investment (ROI) in real time. The fluid predictive analysis of cropping systems for on-time delivery may serve both agricultural uses and medical uses.

Algorithms within the multitiered thermodynamically efficient food feed and bio energy production system can be employed to create efficiencies in the exchange of monetary energy with respect to trade between countries. Specific to the system, labor-intensive crops such as berries can be traded from low labor cost countries for commodity grains or other goods that are needed, for example. In this way, the exchange of monetary energy is made more efficient for both parties (countries/populations) involved. The low cost of labor has a value add to the industrialized (berry/herb/fruit/vegetable) importing country where labor costs are high and the industrialized country which has infrastructure necessary to support large scale mechanized agriculture can supply the underdeveloped country more efficiently with grain crops, for example, that can be harvested more efficiently by machines as technology is applied. Regarding livestock proteins, their production is made more efficient by reducing heat stress within the system located in hot humid equatorial regions, for example, that can more efficiently produce fruits and vegetables than typically lower labor cost than non-equatorial industrialized countries. In addition, the less developed, low labor cost country may use materials such as bamboo to create the clear span structures and vertical grow towers to reduce infrastructure cost, whereas the industrialized country may have infrastructure and technological support to employ higher levels of technology, such as computerized control and monitoring systems, harvest robots etc.

The algorithms predict energy needs within the system at a given time based on what products are being produced and what season it is or what historical weather pattern may occur. The algorithms predict whether energy is best used within the system to maintain a microclimate or sold to the grid during peak energy demand.

This bio system design may reduce water use per unit of production for animal agriculture by incorporating integrated biosystems to generate fresh fruits, vegetables, meat, dairy, fish, and shrimp while providing low energy heating and cooling systems such as liquid desiccant cooling systems and absorption chillers integrated into renewable energy production systems such as geothermal, solar, anaerobic, biologically produced heat, and wind energy systems. Various low grade heat energy reuse and recovery systems may be used to reduce multiple forms of heat energy waste. Low grade heat recovery systems, such as orientation and shape of multi-tiered ducted buildings, liquid desiccant air cooling and dehumidifying, and absorption chilling systems, are low energy utilization systems that can be applied to most locations to decentralize food and medicine production, reducing dependence on petrochemical and fossil fuels, herbicides, pesticides, and antibiotic use in livestock.

Liquid desiccant cooling systems may be utilized in some environments.

Salt water retentate applications may include aquaculture, liquid desiccant cooling systems, evaporative cooling systems, etc., adding value, for example, to drinking water infrastructure for populated areas.

In most climates worldwide, soil types, and topographies, a hydroponic and aquaponic vertical farming system may be set up local to a population. Energy involved in heat conversions and transfers may be optimized in each climate zone in the most efficient design based on the local environment and market needs.

If the system is in a latitude or climate with colder temperatures, then a greater number of livestock may be used in system design to generate adequate heat to maintain a vertical farm greenhouse climate zone. On the more extreme north and south latitudes where winters are harsh, the system creates monetary efficiencies through higher heat recovery values and local production of fruits and vegetables within the system increasing the food value and enzymatic value of fruits and vegetables and increasing supply chain efficiencies through local production. If the exterior climate is not conducive for year-round growth of biological nutrient recovery and filtration, then the system can incorporate larger mechanical filtration systems to a greater extent.

If the system is in a low humidity and temperate environment, more naturally suited to reducing livestock heat stress through evaporative cooling systems, then ventilation systems may comprise entrained air technologies such as tunnel jet fan ventilation systems. The volume of each segment of the tunnel systems may be based on the ideal temperature and air flow rate for each specific species of plant or animal product being produced. A range of 1 mph to 15 miles per hour may be appropriate for a wide variety of plant and animal species.

If the system is in a hot, humid environment, then the volume and length of geothermal trench or cistern may be increased to provide a constant regulated air temperature to the livestock housing unit. If the warm season temperatures are too warm to require excess exothermal heat from livestock housing unit, floor vents in the greenhouse may close and allow heat to pass through to the vacuum vortex silo.

The system may produce or assist in producing algae products and plant-based products. Fermentable sugars, cultured meat products, cultured dairy products, and cultured egg products may be produced within the system. The products of the system may also be used in cosmetic, health, and beauty applications, including medicine. There are many bio energy applications that can benefit by being produced within the system. This biosystem may be used to provide fresh, local, minimally processed, enzyme- and nutrient-rich foods as well as feed, including fruits, vegetables, herbs, fungi, meat, fish, shrimp, dairy, renewable energy, and bioenergy near population centers for efficient distribution.

The system may also produce various forms of bio energy, as well as collect low grade sources of heat to reduce livestock heat stress as well as keep food products cold and other forms of useful heat exchange within the system, thereby reducing energy cost and dependence on fossil fuels.

To grow monetary energy sustainably, the model may take advantage of volatility created by a weakness in conventional agriculture in which mono crop growing systems which are concentrated to the highest yielding soil types or topographies can be affected by weather such as drought, creating scarcity and price increases, or bumper crops creating abundance and price drops.

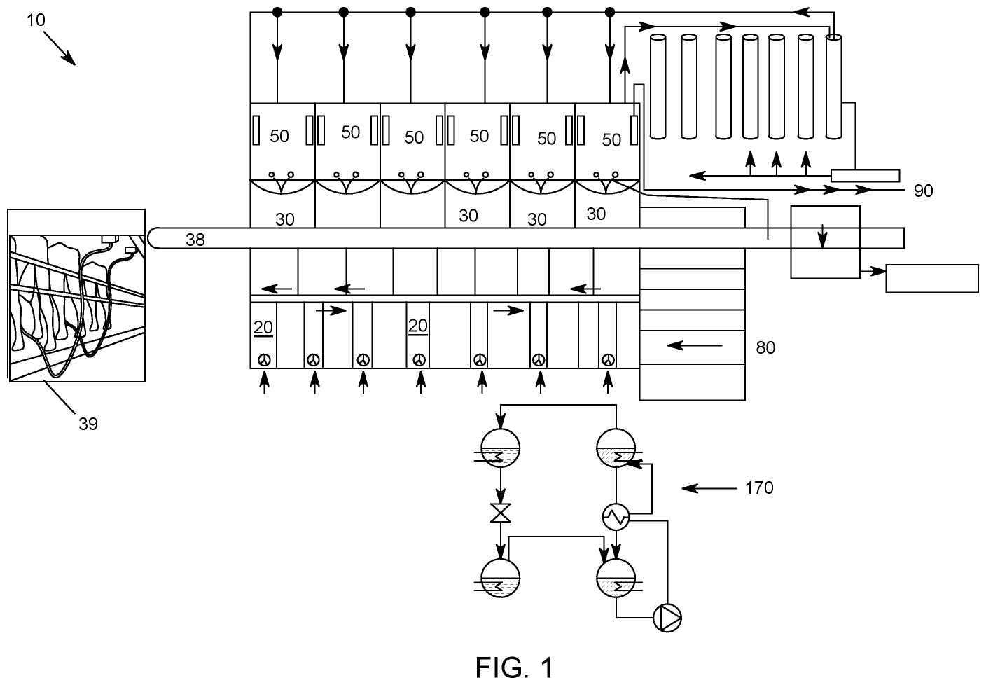

Referring to FIGS. 1, 2A, 2B, and 3 through 14, FIG. 1 illustrates a food production system according to an embodiment of the present invention, including vertical farming 50, a milking parlor 39, livestock modules 30 having a livestock traffic lane/feed lane, with positive airflow and a climate gap 38 at each end, liquid desiccant cooling, aquaculture, a geothermal trench, pretreated water pumped to hydroponic/aquaponic units, biochar production, bladder hot water and an anaerobic digester 80, cold storage utilizing an absorption chiller system 170, fungiculture grow rooms 20 with exiting air treated utilizing bio balls, biogas boiler, containers for flush water, desiccant, fermentation, water, ethanol, glucose, and pretreated water, and a steam turbine. Effluent produced from an anaerobic digester is discharged to a pond 90 which may have perennial evergreen bamboo cane windbreaks.

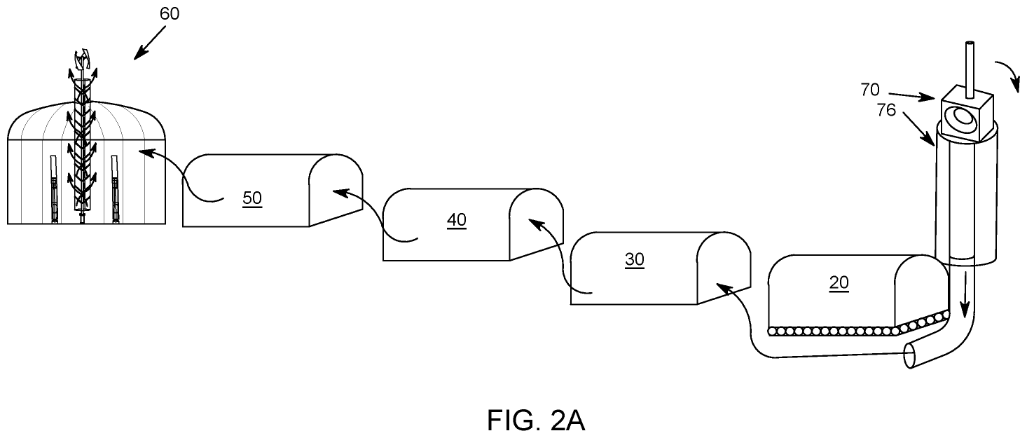

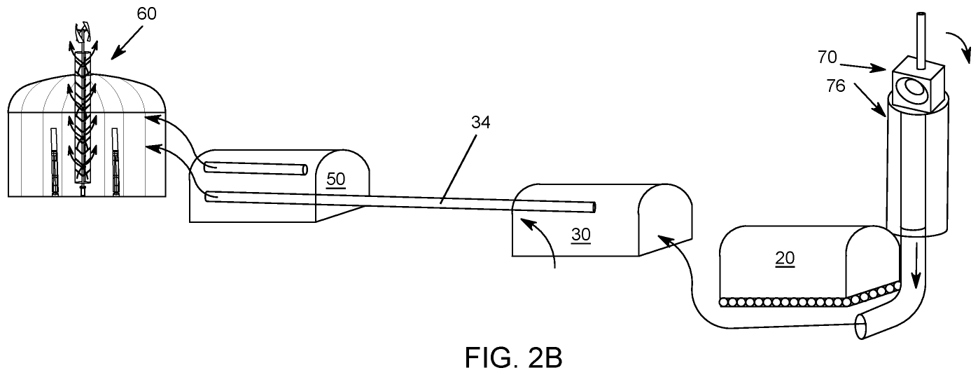

FIGS. 2A and 2B illustrate the tiered nature of the inventive food production system. The modules are illustrated as tunnels, which are advantageous because they contain less airspace than a barn, requiring less energy to heat and cool the space, i.e., the energy does not dissipate within the tunnel. However, existing structures can be retrofitted to serve as modules for the inventive system. As shown in FIG. 2A, air is drawn into a below ground level fungiculture module 20, for example, using a wind scoop 70 that rotates to receive wind regardless of which direction the wind blows. The fungiculture module 20 may have a geothermal trench, which is operative to maintain an ideal temperature of about 53-60° F. The fungi consume oxygen and produce carbon dioxide. Warm air rises and is routed to a ground level livestock module 30, within which livestock such as ruminants or pigs are kept in a microclimate having a temperature ranging from the temperature of the fungiculture module up to about 65 or 75° F. The livestock consume oxygen and produce carbon dioxide. Due to the exothermic nature of livestock, hot air is produced and is routed to an above ground module 40 containing poultry, perhaps for egg production, within a microclimate having a temperature of about 70-75° F. Hot air rising from the poultry module 40 is routed to an elevated vertical tower farm or greenhouse 50, which may be kept at a temperature of about 75-85° F. The greenhouse crops consume carbon dioxide and produce oxygen. Air exiting the greenhouse 50 is combined with air from a kiln heated with bio-oil and/or biochar production, to drive a vertical vortex turbine 60, thereby recovering energy from the exhaust air. As FIG. 2B demonstrates, the modules may be reconfigured. In this case, the illustrated system includes a fungiculture module 20; a poultry, egg production, and/or ruminant module 30; and a vertical hydroponic farm 50. As shown, the air is collected and transported via graduated ascending ducts 34. While not shown, pipes may be run from the geothermal trench under other modules to further control the temperatures.

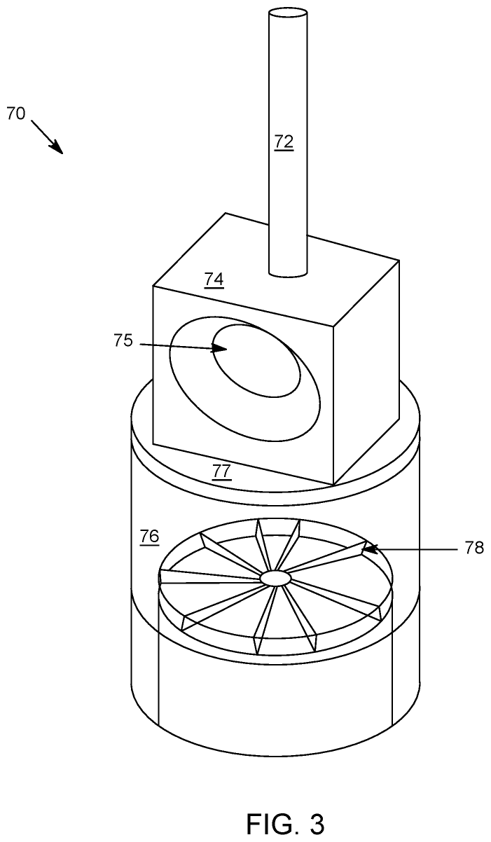

FIG. 3 illustrates the weathervane windsock/wind scoop 70 of the system. As shown, the wind scoop 70 has a body 74, rotatable on a base 76 via a track 77, with a horizontally oriented inlet 75 and a vertically oriented outlet (not shown). A sail or fin 72 mounted on top of the body 74 enables the wind scoop 70 to always face the wind. In the event that insufficient airflow is produced, windmill blades 78 may be used to draw air into the module 20.

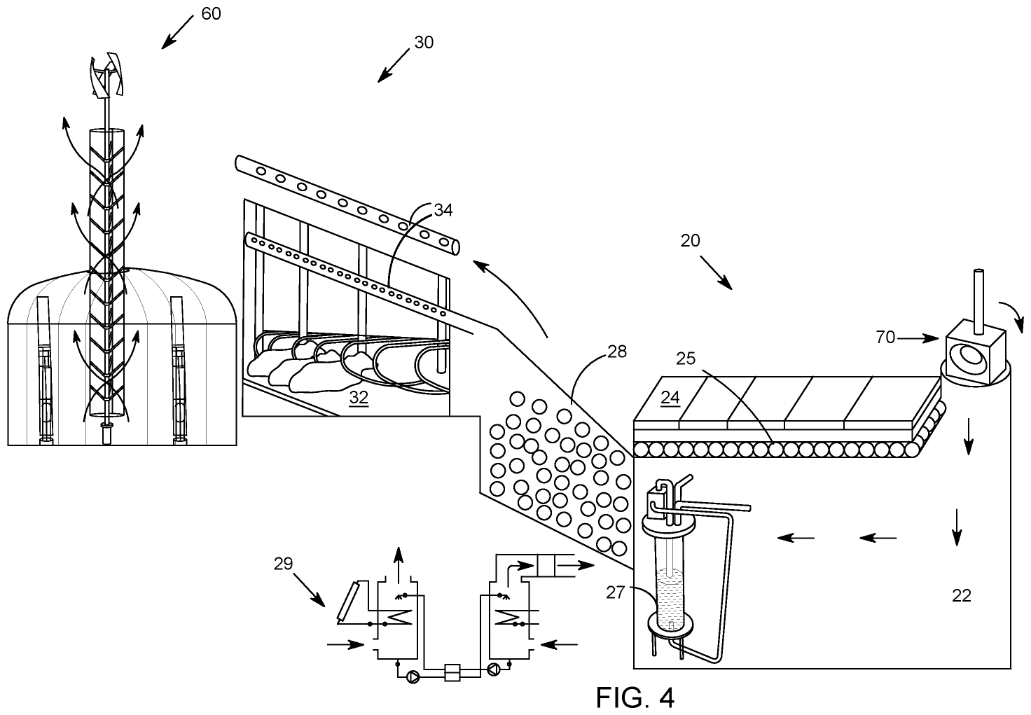

Turning to FIG. 4, a geothermal cistern or trench module 20 is shown, which may have an inner space 22 about 15-20 feet deep to precool incoming air. The air is drawn in via a weathervane windsock 70 which pivots on a bearing track (see FIG. 3) so that it always faces into the wind. Solar panels 24 installed on top of the module may heat desiccant. The panels may have polymer/glass covers, a high-density polyethylene (HDPE) liner, and a low tunnel passing therethrough. The panels may be separated from the trench by a layer of hard insulation and hollow core insulative panels 26. Rising air leaving the module is filtered utilizing biochar 27 and cooled with a liquid desiccant cooling system 29 in a duct 28 having bio balls to increase surface area before being distributed in a livestock module 30, via ducts 34, to livestock in free stalls 32.

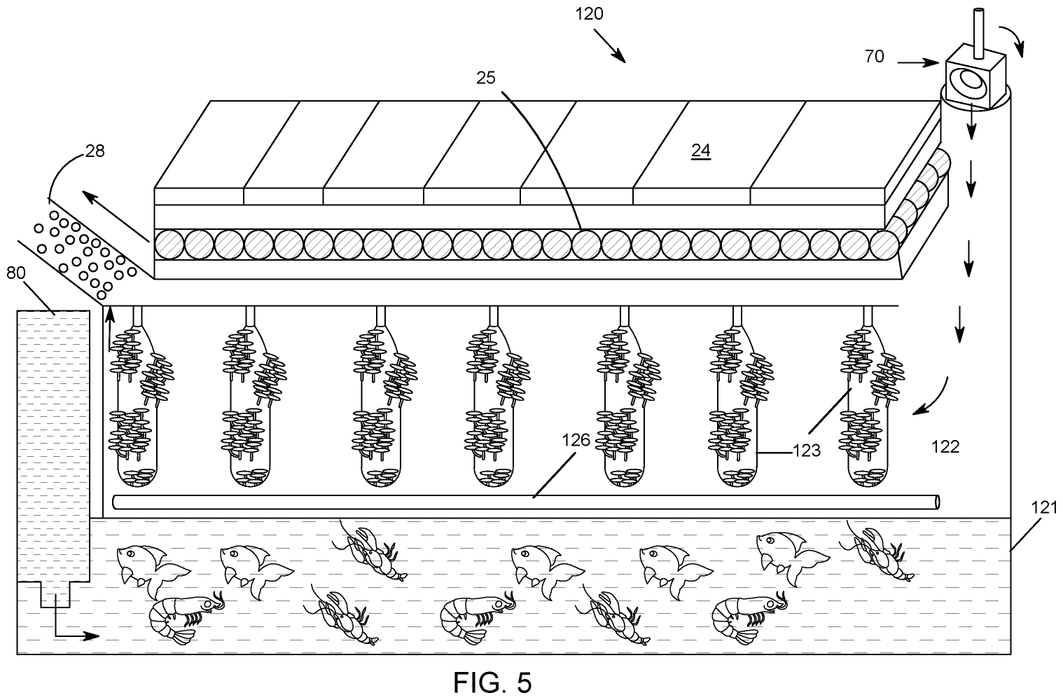

FIG. 5 illustrates a fungiculture and aquaculture module 120 in a geothermal cistern. The airspace 122 is separated from a water region 121 with a floor or barrier 126. Mushroom bags 123 are suspended in the airspace 122. Water or nutrients 80 are released into the water region 121.

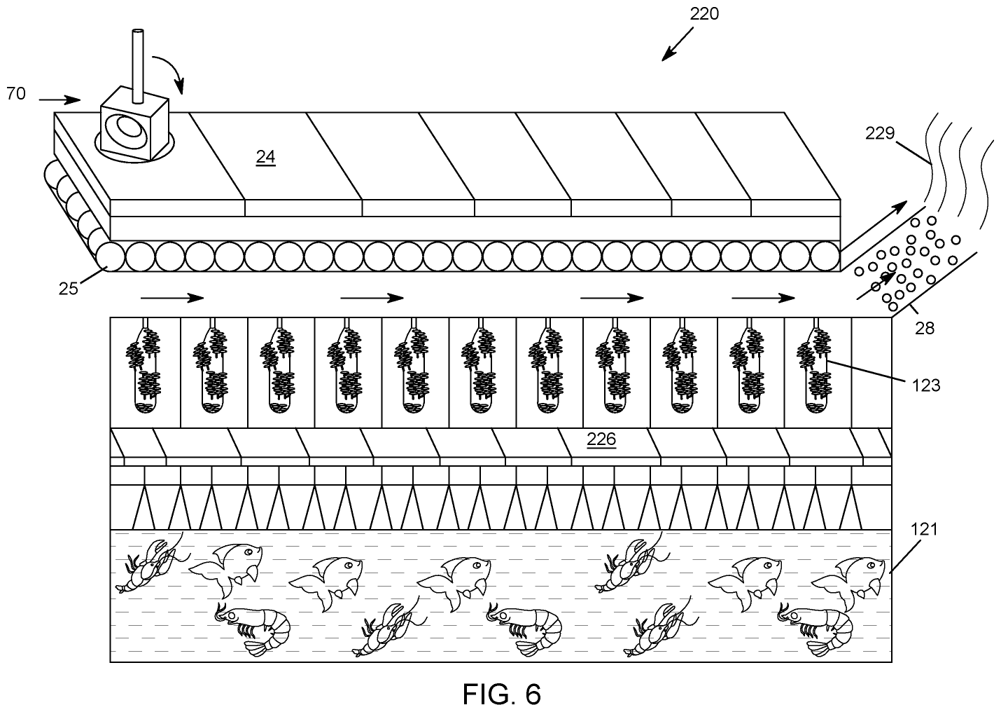

FIG. 6 illustrates a fungiculture/aquaculture module 220 according to another embodiment of the present invention. As shown, the module 220 is provided with a floating dock 226, enabling a worker to access the mushroom bags 123. Air rising from the module 220 is additionally cooled and filtered by a water wall 229.

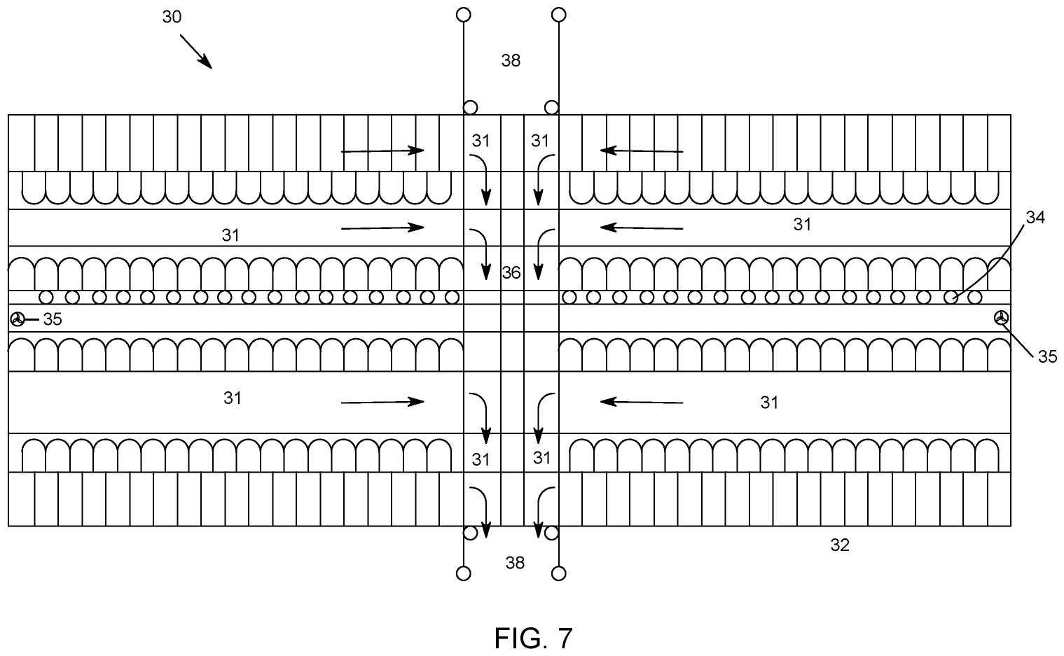

A schematic of a multiple livestock module 30 is shown in FIG. 7. The module 30 may house a variety of livestock within a common structure, such as pork, dairy cattle, beef cattle, poultry, sheep, goats, and egg-laying poultry. Midway along the unit 30, climate gaps 38 are provided on each end of a feed lane 36 to maintain livestock health. A climate gap 38 may be provided for access to, for example, a milking parlor 39. The unit 30 may have a flush lane 31 for collecting waste between each segment, as well as at least one livestock traffic lane (not shown). Air flow may be enhanced utilizing tunnel jet fans 35, in addition to the air delivered by vent 36.

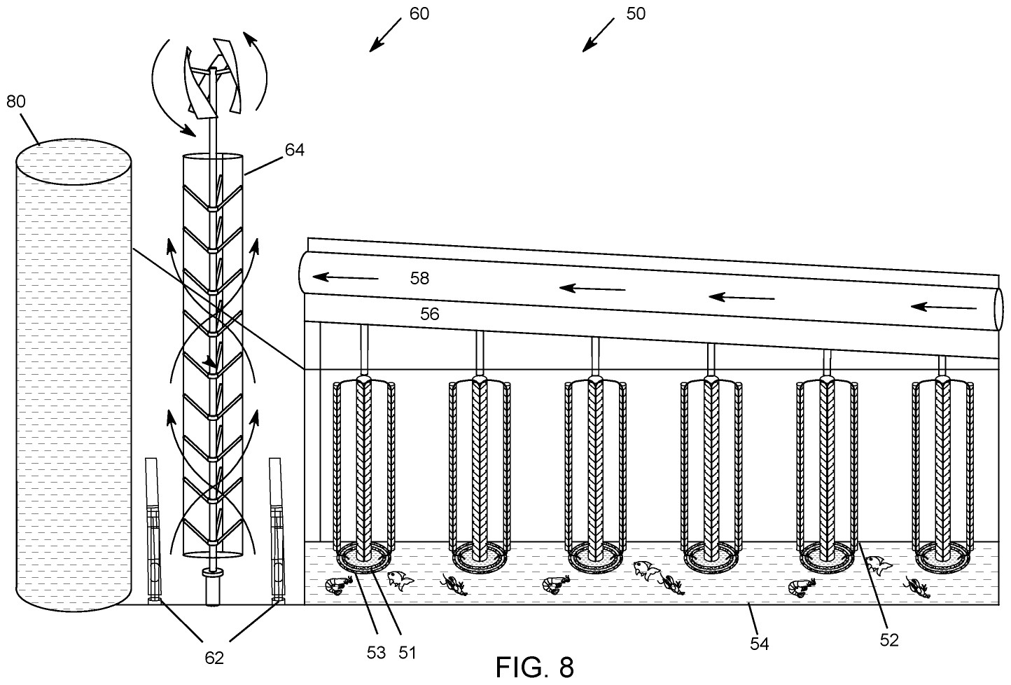

FIG. 8 illustrates a greenhouse 50 containing multitiered vertical growing towers 52 which draw water from an aquaculture pond 54, e.g., wicked via rayon rope and/or by drip irrigation (not shown), which may contain free floating aquatic plants, such as duckweed. The towers 52 may have a central reflective coating and LED strip lights (not shown) to distribute light to the crops. As shown, the base of each tower 52 is a concrete bowl 51, which floats on a layer of water within another concrete bowl 53. The towers 52 may be rotatably supported by an overhead structural beam 56, such as by cables and steel rods connected by turnbuckles (not shown). Air rises from floor level vents (not shown) to enter a gradually elevated duct 58, delivering air to a turbine module 60 including bladeless turbines 62 and a vertical vortex turbine 64. Waste may be collected and treated within an anaerobic digester 80.

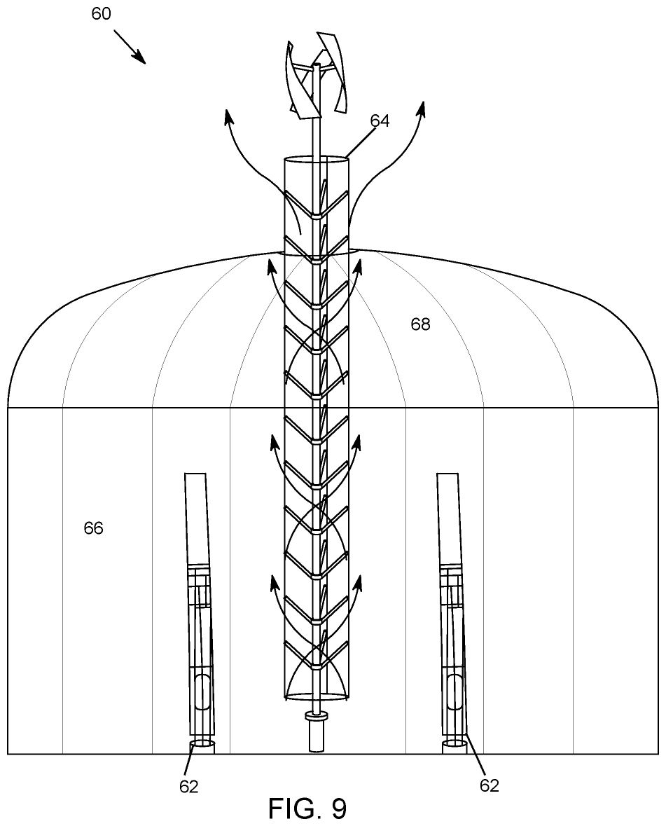

As shown in FIG. 9, the vertical turbine 64 and the bladeless turbines 62 may be housed in a modified silo or grain bin 66, helping to drive the air through the system. Raised solar heat collectors 68 on the dome of the silo 66 further heat the air.

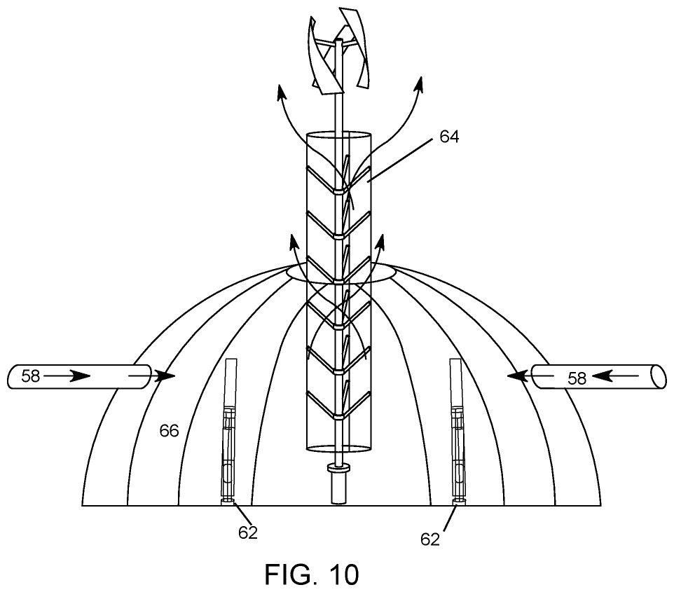

As shown in FIG. 10, ducts 58 from various modules 50 may be routed directly to a common turbine silo 66 in some embodiments.

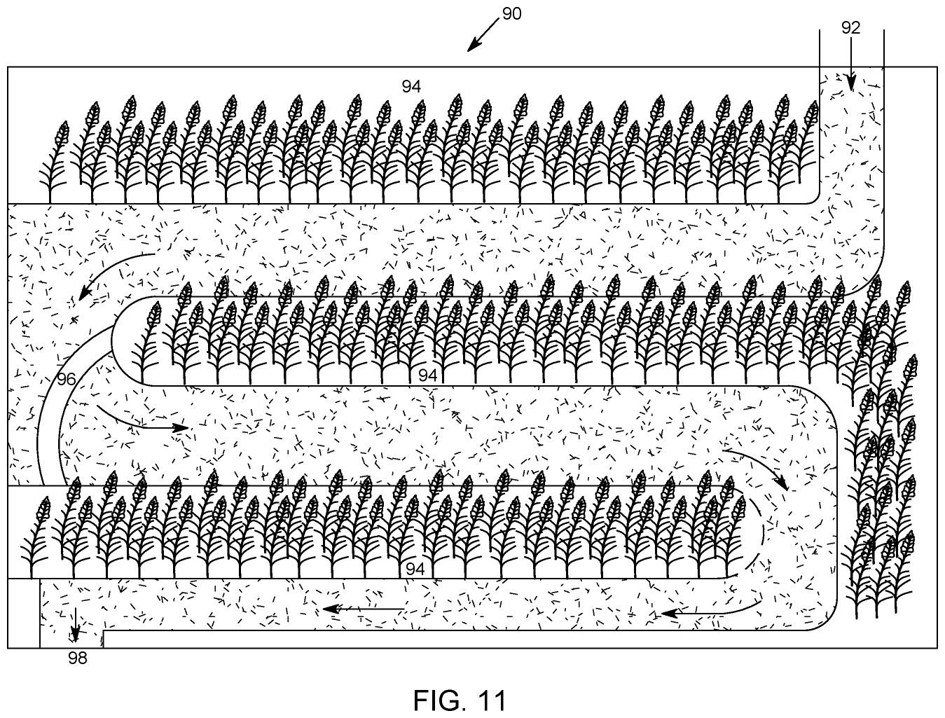

FIG. 11 discloses an artificial wetland or serpentine duckweed pond 90. Effluent from the anaerobic digester 80 is discharged to an entrance 92 to the pond and moves slowly through the serpentine track, enabling duckweed and/or azolla to grow. Between lengths, bamboo/river cane windbreaks 94 allow the plants to grow undisturbed. The aquatic plants may be harvested at an oil boom 96 that extends from one edge to the other edge of one corner of the track. Water leaving 98 the pond may have solids separated and dewatered for further use, while the water remaining may be reused or discharged. The plants may be fermented, for example.

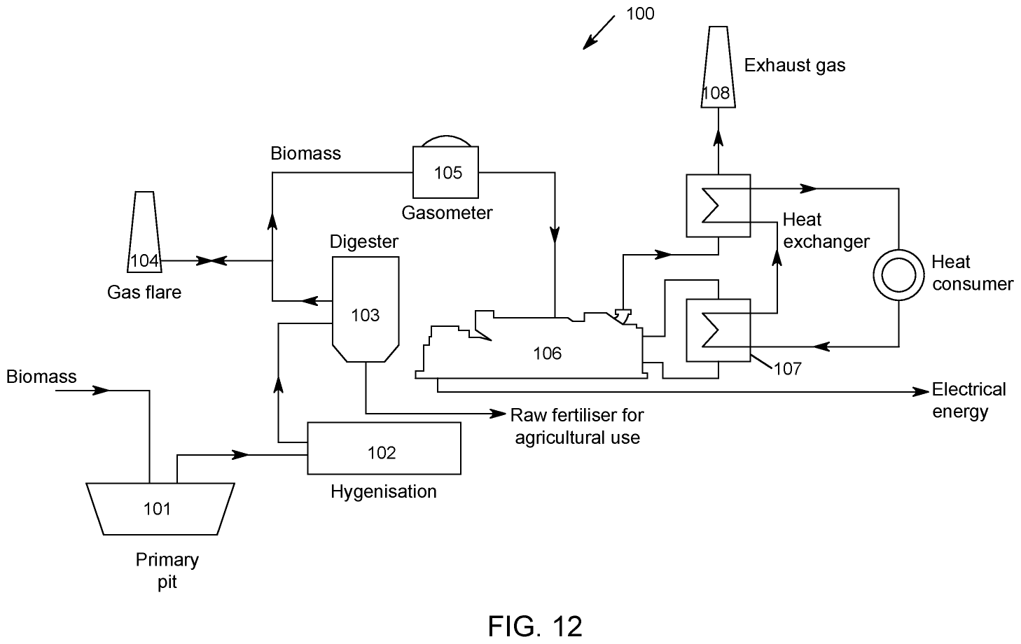

Biomass may be converted at about 800° F. to biochar and heated water utilizing a system 100 such as the one shown in FIG. 12, although a biomass kiln may be produced by retrofitting a roll-of dumpster with a lid (for biochar removal), a water pipe loop system, a high heat duct fan, a supply control valve, and a variable speed air supply fan (not shown). The biomass enters a primary pit 101 to produce an intermediate byproduct that may be delivered to a hygienization unit 102, and then to a digester 103, adding or removing gas to a gas flare 104. Biomass from the digester 103 may be routed through a gasometer 105 and combusted in a furnace 106 to produce electrical energy. Heat is recovered by a heat exchanger 107. Solids from the digester may be removed as raw fertilizer for agricultural use. Exhaust gas 108 may be routed to the turbine silo 66.

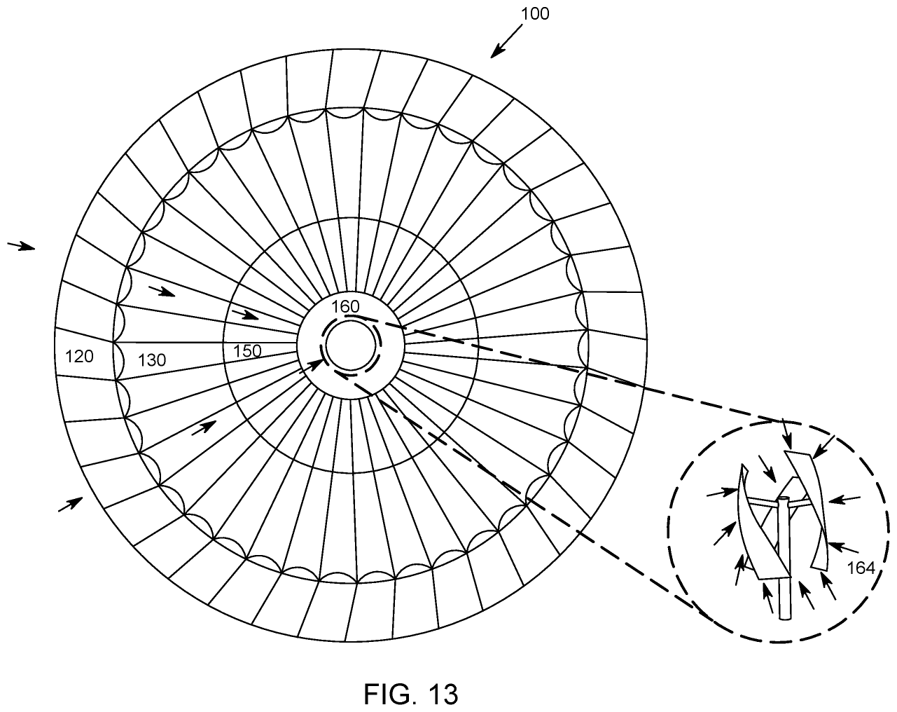

While a linear or parallel module arrangement is envisioned, the system 110 may have modules 120, 130, 150, 160 arranged in a ring, with air being collected at a central turbine 164, as shown in FIG. 13.

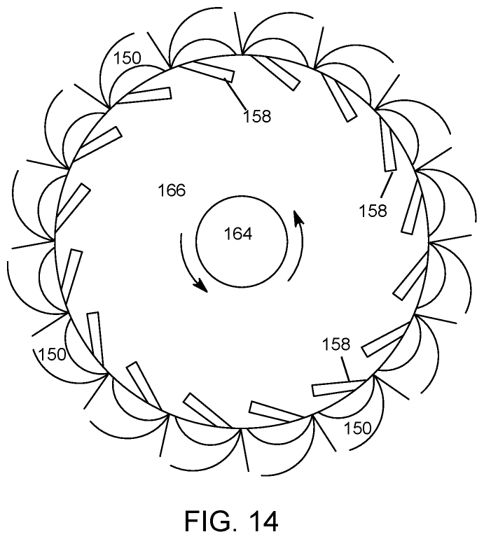

FIG. 14 illustrates a series of angled vents 158 feeding air into turbine dome 166 from several modules 150, further creating a vortex.

It should be understood, of course, that the foregoing relates to exemplary embodiments of the invention and that modifications may be made without departing from the spirit and scope of the invention as set forth in the following claims.

What is claimed is:

1. A tiered, modular agriculture system, comprising:
a livestock module at ambient ground level and having a first interior microclimate; and
a second module having a second interior microclimate elevated with respect to the livestock module and receiving air therefrom by way of a noncorrodible, graduated slope, heat collection duct.

2. The tiered, modular agriculture system of claim 1, wherein the second module is a greenhouse containing vertical horticulture towers.

3. The tiered, modular agriculture system of claim 2, wherein the vertical horticulture towers comprise a self-watering mechanism comprising a wicking rope with spaced apart reservoirs affixed thereto.

4. The tiered, modular agriculture system of claim 2, wherein the vertical horticulture towers have a central column with a bowl-shaped concrete base floatingly resting on a layer of water within a bowl-shaped concrete support.

5. The tiered, modular agriculture system of claim 2, wherein the greenhouse further comprises floor vents operative to receive the air from the livestock module.

6. The tiered, modular agriculture system of claim 1, further comprising a wind generator fluidly communicating with an outlet of the second module and a vertical axis turbine operative to receive wind generated from the wind generator and to generate electricity therefrom.

7. The tiered, modular agriculture system of claim 6, further comprising a solar heat collector operative to heat air entering the vertical axis turbine.

8. The tiered, modular agriculture system of claim 1, further comprising bladeless wind turbines operative to generate electricity from air exiting the second module.

9. The tiered, modular agriculture system of claim 1, wherein the livestock module further comprises a variable frequency driven fan.

10. The tiered, modular agriculture system of claim 1, further comprising a wind generator fluidly communicating with an inlet of the livestock module.

11. The tiered, modular agriculture system of claim 1, further comprising a geothermal trench module having an insulative roof, the geothermal trench module being vertically recessed with respect to the livestock module, wherein the geothermal trench module is operative to house vertical horticulture towers or mushroom media bags.

12. The tiered, modular agriculture system of claim 11, wherein the geothermal trench module further comprises a floating marina dock.

13. The tiered, modular agriculture system of claim 1, further comprising an air filtration system.

14. The tiered, modular agriculture system of claim 1, further comprising a dehumidifying chamber.

15. The tiered, modular agriculture system of claim 1, further comprising a pivotable wind scoop.

16. The tiered, modular agriculture system of claim 1, further comprising a liquid desiccant air cooling system.

17. The tiered, modular agriculture system of claim 1, further comprising an effluent collection system comprising a chemical composition sensor.

18. The tiered, modular agriculture system of claim 1, further comprising a module selected from the group consisting of an aquaponics module, a hydroponics module, an aquatic plant production module, and any combination thereof.

19. The tiered, modular agriculture system of claim 1, further comprising a control system operative to control one or more components selected from the group consisting of rollup doors, fan speeds, pumps, activating solenoids, valves, shades, air ventilation louvers, motors, LED lights, and circuits.

20. The tiered, modular agriculture system of claim 1, wherein the livestock module and the second module each have an internal weather station operative to measure air characteristics selected from the group consisting of oxygen content, carbon dioxide content, methane content, relative humidity, dew point, air speed, temperature, and any combination thereof.
